(19) United States
(12) Patent Application Publication
(10) Pub. No.: US 2003/0037076 A1
(43) Pub. Date: Feb. 20, 2003

(54) Method, computer program and system for style sheet generation

(75) Inventors: Andrew James Frederick Bravery, Salisbury (GB); Alan William Knox, Cheltenham (GB); Simon Laws, Odiham (GB)

Correspondence Address: A. Bruce Clay, IBM Corporation T81/503, PO Box 12195, Research Triangle Park, NC, 27709, US

(73) Assignee: International Business Machines Corporation, Armonk, NY

(21) Appl. No.: 10/094,202

(22) Filed: Mar. 8, 2002

(30) Foreign Application Priority Data
Mar. 8, 2001 (GB) 0105658.9

(51) Int. Cl. G06F 17/24

(52) U.S. Cl. 707/517

(57) ABSTRACT

Device-type-specific XSLT style sheets (or equivalent) are generated from page layout files or ‘presentation skeleton’ files which define a Web page layout including abstract component references that can be mapped to complex, device-specific or repeated style sheet components and are more easily constructed than XSLT style sheets. The presentation skeleton files use and extend existing mark-up languages. One presentation skeleton file can be used to generate XSLT style sheets for many devices that use the same mark-up language. In addition, presentation skeleton files can be produced directly from storyboard files to demonstrate Web sites statically before constructing them for real. This provides a route from initial Web site design to final implementation for multiple output devices.

### FIELD OF INVENTION

The present invention relates to methods, programs and apparatus for supporting presentation of information on multiple device types, and in particular for generating style sheets representing processing operations to be performed on input data to create an output with desired presentation characteristics.

### BACKGROUND

With recent rapid increases in the range of commercially available data processing and communications devices, and their enormous commercial success, many Web-based applications (Web sites) are now being extended to support device types other than the standard personal computer. For example, many companies want to provide access to their Web sites through mobile telephones, hand held computers and digital television systems. As this kind of technology becomes mainstream so the number of device types that a Web site can be presented through will grow.

Each of these device types has different capabilities, for example, screen size, colour support, ability to display images. Implementing and managing the software that is required to tailor a Web site for these many device types is a growing problem. The amount of effort required to support one device type is potentially duplicated when another device type is added.

One popular approach to solving this problem is to separate the data of a Web site from the presentation of that data on any particular device type. The data in a Web application can be represented using the extensible Markup Language (XML). As represented in FIG. 1, input XML data 10 can then be transformed into the presentation 30 for a particular device type using style sheets 20, which are programmatic representations of the processing operations or transformations to be performed on input data to create an output with desired presentation characteristics.

One example of style sheets of current interest is extensible Stylesheet Language Transformation (XSLT) style sheets. XSL is based on the earlier Document Style Semantics and Specification Language and Cascading Style Sheet language. XSL is a language for expressing style sheets which describe presentation characteristics such as which data fields of an XML file are to be displayed, where they are to be displayed on the page, and how to display them (for example, which font to use for text). XSL consists of two parts: the XSLT language for defining transformations for transforming XML documents into a new XML document structure; and an XML vocabulary for specifying formatting semantics. An XSL style sheet processor accepts a document or data in XML and an XSL style sheet and produces the presentation of that XML source content that was intended by the style sheet designer. Further details can be found in the W3C XSL Working Group's draft specification for the Extensible Stylesheet Language (XSL) Version 1.0, W3C Working Draft Mar. 27, 2000, by Sharon Adler et al, or later versions.

An XSLT stylesheet consists of a number of templates. A template can be thought of as a rule that defines what output should be generated when a particular pattern appears in the input. An XSLT processor takes the source XML, transforms it according to the templates in the stylesheet, and writes out the result. Default behaviour is defined to handle patterns appearing in the input that are not matched by templates in the stylesheet.

XSLT is a declarative language. The templates define output derived from particular circumstances in the input and are independent of each other. An XSLT stylesheet defines the collection of templates that will be applied in a particular run of an XSLT processor. XSLT includes statements that allow one stylesheet to import or include another. The result is that the single stylesheet applied by an XSLT processor at run-time may in fact be composed of a number of smaller stylesheets, each of which also has its own separate existence. This allows code reuse and promotes a modular architecture for XSLT applications.

XSLT processors will read source XML and stylesheets from files and write result documents to files so can be used in a batch process. They will typically also have some API that allows them to be driven programatically. The Apache Software Foundation's Xalan XSLT style sheet processor (available from the Apache XML Project at Web site xml.apache.org) is an example that exposes a Java API. This Java API allows sources, stylesheets and results to be presented via either the SAX or DOM APIs or as streams. Further, it allows the result from the execution of one stylesheet to be piped directly into the input source of another; or be used as the stylesheet for another.

XSLT style sheets must be written for each Web page and for each device type. For example, as shown in FIG. 2, six style sheets 20 are typically required to support two pages 10 across three devices 40. This style sheet count can be reduced to a certain extent by introducing parameters to the style sheets. Generally, though, in their raw form these XSLT style sheets can be complex and difficult to construct and maintain and this is a major problem if the number of pages or device types is large.

### SUMMARY OF INVENTION

The present invention provides a method and apparatus implementing a process through which device-type-specific XSLT style sheets (or equivalent) are generated from relatively simple page layout files or ‘presentation skeleton’ files. These presentation skeleton files define the Web page layout but include abstract component references that can be mapped to complex, device-specific or repeated style sheet components of the final device-specific style sheets, and so are more easily constructed than XSLT style sheets. Web page presentation skeleton files preferably use and extend the mark-up languages used by the devices themselves. One presentation skeleton file can be used to generate XSLT style sheets for many device types that use the same mark-up language.

In addition to generally reducing the effort of generating style sheets and helping to ensure consistency within a style sheet and between style sheets, another advantage of the present invention is that it is possible to produce presentation skeleton files directly from the storyboard files which are often generated by design agencies to demonstrate Web sites statically before they are constructed for real. Thus, the present invention provides a route from initial Web site design to final implementation for multiple output devices.

In a first aspect of the invention, there is provided a method of generation of a style sheet for applying presentation characteristics to Web page content for presentation by a presentation device, the method of generation including the steps of: responsive to specified Web page presentation characteristics, generating a Web page presentation skeleton comprising a page layout definition which includes a representation of a subset of the specified presentation characteristics and references to one or more style sheet components corresponding to a second subset of said presentation characteristics; and performing one or more style sheet transformations on the Web page presentation skeleton to replace said references with the corresponding style sheet components.

Preferably, the referenced style sheet components include style sheet components (for example, XSL statements) for applying presentation characteristics to dynamic XML data which is retrieved from a Web server and inserted into a Web page at run time. Dynamic data in this context is data which may be updated on the Web server such that it is necessary to retrieve it from the Web server at run time to ensure that only up-to-date data is used. The referenced style sheet components preferably include, additionally or alternatively, one or more blocks of presentation markup language comprising either device-specific markup or markup which is repeated in other Web pages.

The separation of certain style sheet components from a ‘presentation skeleton’ page layout definition, followed by subsequent transformation to create a final style sheet, simplifies style sheet generation since presentation skeleton files can be created relatively easily from input HTML, especially if complex style sheet components are predefined and provided within a style sheet generator CASE tool. Furthermore, the Web page layout information and component references of a presentation skeleton can then be reused for different types of output device by using alternative device-specific markup components. The invention also enables easier modification of Web page presentation and helps to ensure consistency, since style sheet components that are referenced multiple times only need to be modified once for a consistent change across the Web page or Web site.

The Web page presentation skeleton preferably comprises a markup language file including markup tags which are the references to separately-stored style sheet components. In one embodiment of the invention, a set of XML tags are defined for inclusion in Web page layout definition files to identify specific XSL components and other presentation markup components and to indicate locations in which to insert the identified components. The style sheet components are inserted in place of the tags as part of an XSL transformation, or a sequence of XSL transformations, subsequent to the steps of designing the Web page and creating the layout definition, to create a style sheet. The style sheet components may be created by a Web page designer or may have been created previously as an independent operation and then held in a style sheet component repository (for example, within a CASE tool) for use when creating XSLT style sheets. A presentation skeleton file is preferably built for each combination of a Web page and a distinct markup language (such as HTML or WML) to define how the page will look in a given markup language but, unlike the final style sheets, presentation skeletons are not tied to the detailed requirements of an individual target display device.

The set of style sheet components may include XSL components for transforming any input XML items, but preferably include XSL statements to dynamically insert XML content at run time and/or components which introduce device-specific markup. The former serves to separate out a category of complex components from the basic page layout since selections, sorts and reordering of input XML is relatively complex, while the latter allows the presentation skeleton to be generic and hence reusable for different device types within a class of devices (for example those which present data using WML decks, or the class of devices which present HTML). Advantageously, style sheet component references are also used to reference style sheet components which appear on more than one page in the site, both removing repetition when designing the page layout for a client device and helping to ensure consistency of look and feel within a Web page or across multiple pages. The invention facilitates ease of management of the presentation of Web page content across the application.

The style sheet components thus may be specific to a page, specific to the site, or generic across many sites, and provide a mechanism for abstracting common content, complex content and device-specific content to separate this from the overall page design. For example, for a given page and markup language, changing the details of the style sheet components used to generate the run-time style sheet can cater for differences in device characteristics and can be used as a simple mechanism for changing the look and feel of the whole site. For example, a navigation widget used repeatedly within an HTML file can be extracted as a referenced component, and then the look and feel of the Web site can be changed by changing the referenced components. The invention provides a concentrated view of a Web page design.

Style sheet components may include references to other style sheet components, such that the transformation of a presentation skeleton may involve an iterative sequence of XSL transformations until all component-reference tags have been replaced.

Web page presentation characteristics and content are typically specified by a Web page designer (for example, creating a set of static HTML pages) and then the step of generating a presentation skeleton may be automated within a computer program tool which applies predefined rules (fixed or user-selected rules) to the specified presentation characteristics to identify characteristics which should be handled as referenced style sheet components. Alternatively, the presentation skeleton or parts of it may be generated in response to a user identifying and manually flagging characteristics to handle as referenced style sheet components. Of course, a page layout definition and a presentation skeleton file which represents it could also be created entirely manually.

The style sheet transformations which are performed on the Web page presentation skeleton to replace component references with corresponding style sheet components preferably entail applying one or more style sheet templates, which templates each define the association between at least one of said references and a corresponding style sheet component. A style sheet template can be thought of as a rule that defines what output should be generated when a particular pattern appears in the input, and an XSLT style sheet consists of a number of templates. The “expansion” of component references via style sheet transformations preferably results in a data structure which is very close to a final XSLT style sheet but uses a component name format other than standard XSL names to avoid inserted XSL statements being immediately executed by an XSLT processor. The use of an alternative namespace for the reference tags and associated components also aids identification of the tags when pre-processing them to insert XSL components. This step is then followed by a namespace conversion to generate the final XSLT style sheet which has standard-format XSL component names.

The steps described above of generating a Web page presentation skeleton comprising a layout definition and component references, and then using XSLT style sheets to transform the presentation skeleton to create a new XSLT style sheet, are not known from the prior art. The generated XSLT style sheet can then be used at run time to add the presentation required by a device to the data provided in an XML structure, as is known in the art. An XSLT processor takes source XML, transforms it according to the templates in a style sheet which it reads from a file, and writes out a result, and this run time processing is the same for style sheets generated according to the present invention as for style sheets generated conventionally.

In a second aspect, the invention provides a data processing apparatus comprising: a processor; a storage repository for storing a set of style sheet components; and a set of controller components for accessing the storage repository and for controlling the operation of the data processing apparatus to perform a method of style sheet generation, the set of controller components including components for: responsive to specified Web page presentation characteristics, generating a Web page presentation skeleton comprising a page layout definition which includes a representation of a subset of the specified presentation characteristics and references to one or more style sheet components corresponding to a second subset of said presentation characteristics, the referenced style sheet components being held in the storage repository; and performing one or more style sheet transformations on the Web page presentation skeleton to replace said references with the corresponding style sheet components.

In a third aspect, the invention provides a computer program comprising program code components for controlling the operation of a data processing apparatus to perform a method for generating a style sheet, as described above.

The invention is preferably implemented in a tool for creating and editing XSL style sheets, and may be made available as a computer program product comprising program code recorded on a machine-readable recording medium. Such a tool preferably includes a number of predefined XSL components which are known to be useful to Web page designers, but is flexible to enable users also to define their own components.

### BRIEF DESCRIPTION OF DRAWINGS

Embodiments of the invention will now be described in more detail, by way of example, with reference to the accompanying drawings in which:

FIG. 1 is a schematic representation of the separation of XML data from presentation characteristics, expressed in a style sheet, and their combination in a data presentation for display on a device;

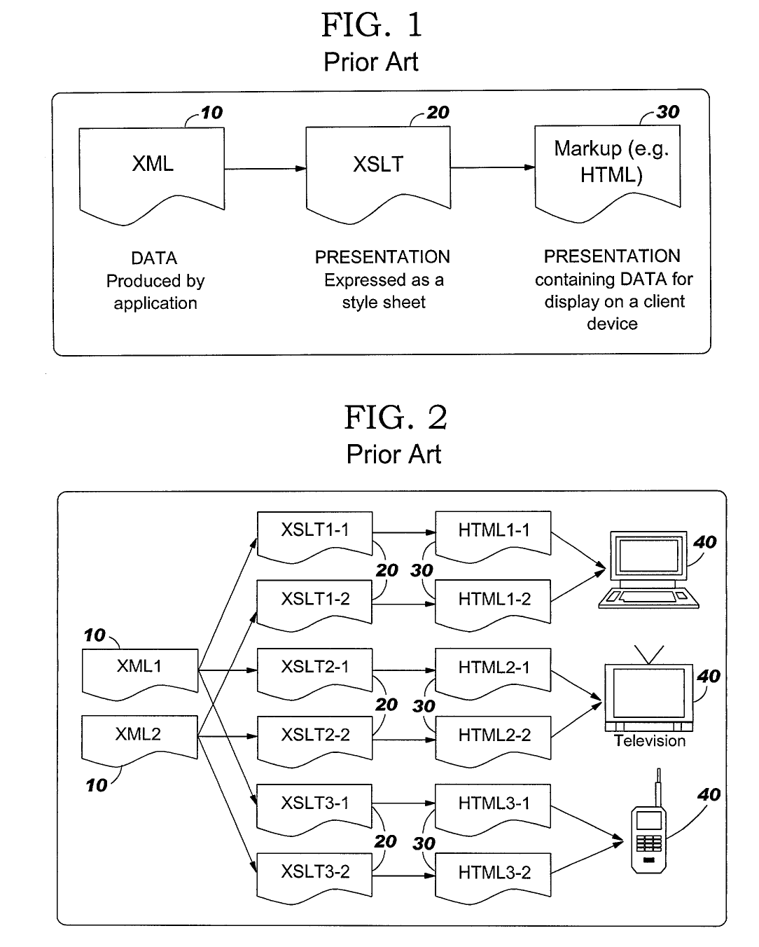

FIG. 2 shows the typical situation of a separate XSLT style sheet being required to transform each XML document for display on each of a plurality of devices;

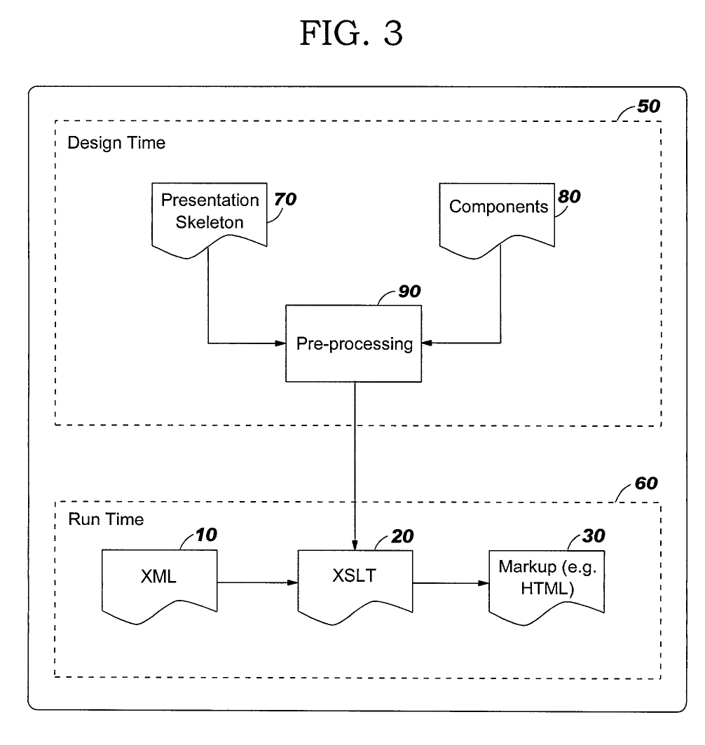

FIG. 3 is a schematic representation of the separate design-time and run-time stages of operation of a system implementing the invention;

FIG. 4 represents the steps of a method according to an embodiment of the invention;

FIGS. 5a and 5b are screen shots of example Web pages presented on a digital television;

FIG. 6 is a screen shot showing the example Web page of FIG. 5b as presented on a PC; and

FIG. 7 is a screen shot showing an alternative layout to the screen shot of FIG. 6, with modified background image components.

### DETAILED DESCRIPTION OF PREFERRED EMBODIMENTS

An XSLT style sheet generator tool implementing the invention according to a first embodiment comprises a computer program for running on any computer system or data processing apparatus that can be used for generating or manipulating representations of Web site presentation characteristics. The tool provides a collection of predefined XSLT style sheets, style sheet templates, and style sheet components as well as features enabling a user to define and select characteristics of further style sheets and templates and to create new style sheet components.

The tool's predefined style sheets include style sheets that can mechanically replace presentation markup with pre-defined tags, as well as style sheets that can mechanically replace pre-defined tags with presentation markup, as will be described below.

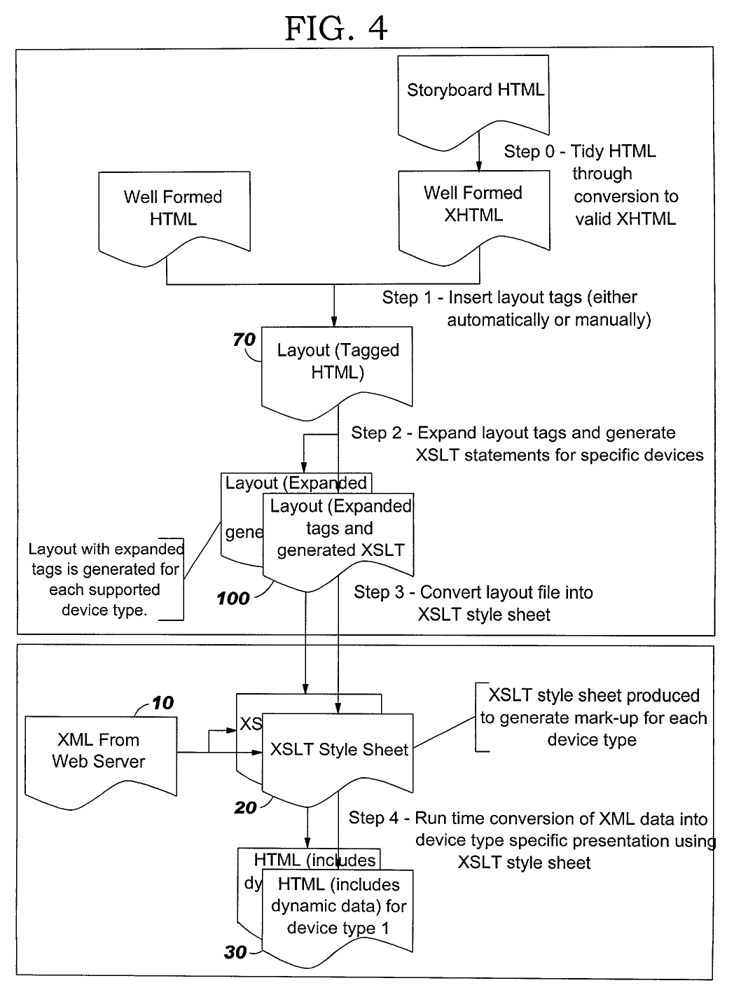

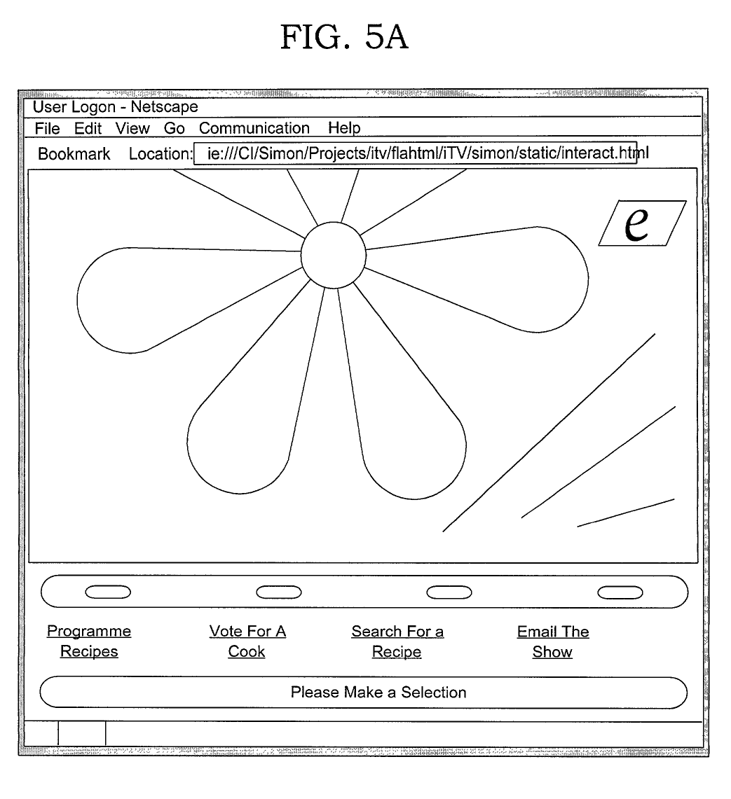

As shown in FIGS. 3 and 4, the steps of using the invention can be separated into separate design time and run time stages. The design time stage 50 for generating an XSLT style sheet involves the following steps:

Generating a ‘presentation skeleton’ 70 or Web page layout definition file which comprises a representation of specified Web page presentation characteristics plus references to one or more specific style sheet components corresponding to other presentation characteristics. This may be generated from analysis of an imported static prototype Web page (such as a set of HTML pages produced by a design agency) or it may be built up from user-entered Web page characteristics and user-defined navigation paths between those pages (that is, the XSLT generation functions of the invention may be incorporated in a tool which supports both initial Web site design and the steps to achieve a complete Web site implementation). Within a graphical design tool, the constructed or imported Web site can be displayed as graphs (one for each supported device) with nodes representing pages and edges representing navigation through the application. Information about pages can be displayed, entered or modified by selecting nodes on the graph to open data entry windows.

Creating the one or more style sheet components 80 and defining tags to reference them, and/or accessing a repository of existing XSL components and presentation markup components to use the existing components.

Processing 90 the presentation skeleton file to replace the reference tags with the relevant style sheet components.

Performing 90 a namespace conversion to transform the inserted style sheet components into standard-name-format XSL components.

The set of XSL components 80 referenced by tags typically include blocks of static markup language code as well as XSL statements which introduce apply presentation characteristics to dynamic data inserted into the Web page from input XML data. The data structures, program code components and process steps mentioned above will be described in more detail below.

Presentation Skeleton 70

A presentation markup file built for each page and for each distinct markup language. For example, the markup language could be HTML or WML. This file defines how the page will look in a given markup language for a class of display device. Where there are significant differences between the presentation on devices that use the same markup language, for example, HTML for Personal Computers (PCs) and Digital Television (DTV) devices, more than one skeleton file per page and markup language combination may be required. In a presentation skeleton, some of the presentation markup required to define the desired presentation characteristics (for a particular Web page, markup language and device class) has been substituted by XSLT statements or special purpose XML “widget” tags that reference components. The markup within a presentation skeleton largely comprises the subset of presentation markup which is unique to a particular page and the component reference tags and XSLT statements are used to reference the subset of presentation characteristics which are shared across many pages as well as the incorporation of dynamic data from a back-end system.

Style Sheet Components 80

Any complex items in the page such as dynamic content, which must come from the XML at run time, as well as device-specific markup and repeated blocks of markup are handled by including in the skeleton references to style sheet components. Components will either be specific to the page, specific to the site or generic across many sites, and provide a mechanism for abstracting common content and device specific content away from the page design. For example, for a given page and markup language, changing the details of the components used to generate the run time style sheet can cater for differences in device characteristics.

The XSLT style sheet generator handles the following XSL components which may be found within a Web application:

Common blocks of markup that will be used across many pages, such as header bars and navigation widgets;

Blocks of XSLT used to extract dynamic data from input XML and to introduce it into the page;

More complex XSLT components which also extract dynamic data from input XML but then go on to render the data in common user interface controls such as drop down selection dialogs;

Blocks of scripting language, for example JavaScript;

Static text kept separate from the page layout for reasons of improved maintenance and commonality across pages;

Hypermedia links to other pages, also kept separate from the page layout for reasons of improved maintainability.

Image references, also kept separate from the page layout for reasons of improved maintainability.

Additional components can be added as required.

Pre-Processing 90

The object of this process is to generate an XSLT style sheet 20 that can be used at run time to add the presentation required by a device to the data provided in an XML structure 10. The pre-processing stage 90 combines the layout held in the presentation skeleton 70 with the details of each referenced skeleton to produce the XSLT style sheet 20 for each device 40 being supported. Component tags in a presentation skeleton are expanded, as described later, to presentation markup, XSLT statements and (possibly) child component tags. This expansion process can be iterated for any given presentation skeleton until all component tags have expanded to presentation markup or XSLT. The ultimate result is presentation mark-up that contains XSLT statements. This can be inverted by a final process step to generate an XSLT stylesheet.

The second stage of implementation is the use of the generated style sheet at run time. The generated XSLT style sheet 20 is used to add the presentation characteristics required by a device 40 (that is, the look and feel defined by the presentation skeleton 70 and its referenced components 80) to the data provided in an input XML structure 10, when the input XML 10 and the style sheet 20 are processed by an XSLT style sheet processor. As there is a pre-processing stage, the run time style sheet can be optimized for performance. Also, changes across the site or for a single device can be effected by modifying the appropriate components and regenerating the run time style sheets.

The sequence of operations involved in use of the invention is represented by way of example in FIG. 4. As an example, this diagram assumes two HTML based devices are targeted. The actual device type is not specified but we assume that the device support for HTML differs enough to require separate XSLT style sheets to be generated.

The design time stage of use of the invention involves a sequence of processing steps the result of which is an XSLT style sheet 20 which will be used to transform incoming XML at run time. If there is no dynamic content to this page then the design-time processing activity will result in an HTML file which can be returned directly whenever the page is requested (not shown). Referring to FIG. 4, the design-time processing steps are as follows:

Step 0—Tidy storyboard markup

This step is required if the presentation skeleton is to be based on markup (for example HTML) that already exists and if that markup is not well formed from an XML point of view. This step is not required if the markup is known to be well formed.

Step 1—Insert Component Reference Tags

Tags are added into the HTML to indicate where components will later be inserted. These tags must either match existing components or new components must be written. The tagged HTML comprises a Web page layout-defining ‘presentation skeleton’ file 70.

Step 2—Replace Component Reference Tags With Components

Where a tag indicates an XSL component and location for dynamic data to be inserted into the page, these tags are converted automatically into XSLT statements which will be processed at run time, except that a namespace other than the XSL namespace (“xsl: . . . ”) is used for certain commands at this stage to avoid them being immediately processed as XSL instructions. Other tags will be converted into static text or HTML. The replacement of tags with XSL components to create an expanded layout definition file 100 may be an iterative process involving a number of XSL transformations if the referenced XSL components themselves contain child XSL component reference tags, continuing until all tags have expanded to presentation markup or XSLT statements.

Step 3—Convert Presentation Skeletons to XSLT Style Sheets

The expanded page layout file 100 including the XSLT commands generated in step 2, is converted into an XSLT style sheet 20 (changing XSL components to an XSL namespace) ready to process incoming XML at run time.

The run time step, Step 4 of FIG. 4, takes XML 10 as input and uses the appropriate generated XSLT style sheet 20 to render the XML data into a presentation 30 for display on the device. The correct XSLT style sheet for the device type must be chosen based on the device type. IBM Corporation's WebSphere Transcoding Publisher product could be used to perform this device-type specific style sheet selection role. (IBM and WebSphere are trademarks of International Business Machines Corporation).

### PROCESS EXAMPLE

Further details of the above-described process will be described using the following scenario as an example.

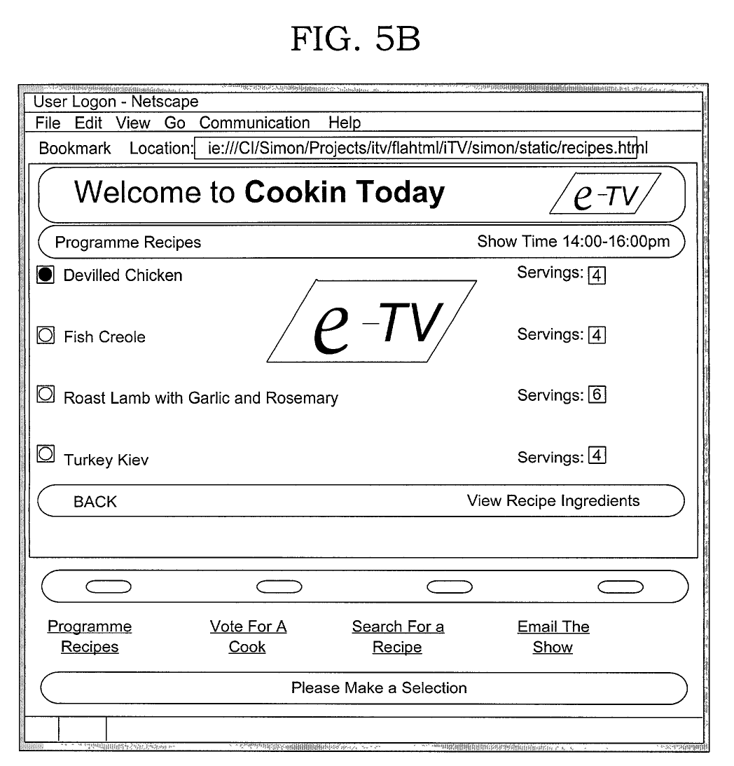

A design agency has produced a static prototype of a new digital television site. The two pages shown in FIGS. 5a and 5b are from this site. The first page, the ‘logon’ page, does not physically provide a mechanism for the user to login but contains a number of links that access other pages in the site. The ‘Programme Recipes’ link leads to a recipes page. The recipes page list recipes that a user may select in order to obtain further details.

The first page has no dynamic data on it but the second contains a list of recipes that the user can select from. This list of recipes is provided by the back end application. An example of the XML that will be returned when we request the list of recipes for display is shown below in Sample Code 1:

xml version=“1.0°?>
<itv>

<categoryList id=“Show time: 19:30”>

<sponsor>

Farm Stores UK
</sponsor>
<category>

<name>Devilled Chicken</name>
<home href=“iTV.hursley.ibm.com/iTVStorelCatl.html”/>
<thumbnail href=“iTV.hursley.ibm.com/graphics/
iTVStorelCatl.gif”/>
<catid code=“1111”/>
<servings>4</servings>

</category>
<category>

<name>Fish Creole</name>
<home href=“iTV.hursley.ibm.com/iTVStorelCat2.html”/>
<thumbnail href=“iTV.hursley.ibm.com/graphics/
iTVStorelCat2.qif”/>
<catid code=,,1112”/>
<servinqs>4</servings>

</category>
<category>

<name>Roast Lamb With Garlic And Rosemary</name>
<home href=“iTV.hursley.ibm.com/iTVStorelCat3.html”/>
<thumbnail href=“iTV.hursley.ibm.com/graphics/
iTVStorelCat3.gif”/>
<catid code=“1113”/>
<servings>4</servings>

</category>
<category>

<name>Turkey Kiev</name>
<home href=“iTV.hursley.ibm.com/iTVStorelCat4.html”/>
<thumbnail href=“iTV.hursley.ibm.com/graphics/
iTVStorelCat4.qif”/>
<catid code=“1114”/>
<servings>4</servings>

</category>

</categoryList>
</itv>

### Sample Code 1

Building Presentation Skeleton Files and Components

The initial target device is digital television. However this is a standard web style application, so there is no real interaction with the digital television picture stream itself, and you could imagine this application being provided via a PC channel as well. As such it is important that we build the HTML pages in a way that we can take account of the differences between the devices. The first page is a case in point. There is no complex dynamic content to be included on this page but the look and feel would still change when moving from DTV to PC devices. In reality the difference in look and feel between DTV and PC devices is different enough to warrant having presentation skeleton files for each, but as an example we can assume there is one presentation skeleton for both classes of device.

Consider the HTML for the login page, as shown in Sample Code 2:

<?xml version=“1.0” encoding=“utf-8”?>
<HTML>

<HEAD>

<TITLE>User Logon</TITLE>
</HEAD>,
<BODY VLINK=“#FFFFFF” Link=“ #FFFFFF” text=
“#FFFFFF” marginheight=“0”

marginwidth=“0” topmargin=“0” leftmargin=“0” background=,,
/images /otherbkg.jpg“
bgcolor=“#FFFFFF”>

<TABLE height=“447” cellpadding=“0” cellspacing=“0”
border-“O” width=“591”>
<TBODY>
<TR>

```
<TD colspan=“5” height=“317”>
  <IMG height=“1” width=“10” src=“/images/trans.gif”/>
</TD> </TR> <TR>
  <TD colspan=“5” height=“37”>
  <IMG height=“34” width=“21” src=“/images/
  MasterLpanel2.gif”/>
```

<IMG height=“34” width=“118” src=“/images/Redbut.gif”/>
<IMG height=“34” width=“171” src=“/images/Greenbut.gif”/>
<IMG height=“34” width=“159” src=“/images/Bluebut.gif”/>
<IMG height=“34” width=“124” src=“/images/Yellowbut.gif”/>
<IMG height=“34” width=“21” src=“/images/MasterLpanella.gif”/>

</TD> </TR> <TR valign=“middle” align=“center”>

<TD valign=“middle” align=“ center” height=“61” width=“140”>

< P>

<FONT size=“4” color=“#FFFFFF”>

<B>

<FONT face=“Arial, Helvetica, sans-serif”>
<A href=“recipes html”>Programme Recipes</A>
</FONT>
</B>

</FONT>
</P>

</TD>

<TD valign=“middle” align=,, center” height=“61” width=“155”>

<FONT size=“4” face=“Arial, Helvetica, sans-serif”
color=“ #FFFFFF”>

<B>
<A href=“dummy.html”>Vote

For A Cook</A>

</B>

</FONT>

</TD>

<TD valign=“middle” align=,, center” height=“61” width=“196”>

<FONT size=“4” color=“#FFFFFF”>

```
<B>
  <FONT face=“Arial, Helvetica, sans-serif”>
  <A href=“search.html”>Search
```

For a Recipe</A>

</FONT>
</B>

</FONT>
</TD>

<TD valign=“middle” align=“ center” height=“61” width=“145”>

<FONT size=“4” face=“Arial, Helvetica, sans-serif”
color=“ #FFFFFF”> <B>

<A href=“email.html”>Email

The Show</A>

</B>

</FONT>

</TD>

<TD height=“61” width=“24”>

<IMG height=“1” width=“10” src=, ‘/images/trans.gif,’/>

</TR>
<TR>
<TD colspan=“5” align=“center”>

<IMG height=“46” width=“6401’ src=“/images/
Selecionbox.jpg“/>

</TD>
</TR>

</TBODY>
</TABLE>

</BODY>
</HTML>

### Sample Code 2

As described above, a presentation skeleton file is used to provide device independence, consistency and reuse across the site. It does this by referencing, as components, all of those items in a layout file that introduce dynamic content into the page and the items which are likely to appear on more than one page or that may be device specific. The Presentation Skeleton Files can be built automatically, semi-automatically or manually. Either they can be written from scratch manually or they can be derived from existing markup language files using automated tools.

In this example, there are static HTML files from which our presentation skeletons can be derived. The HTML of Sample Code 2 is presented as XHTML. The XHTML is obtained by passing standard HTML, such as provided by a design agency, through a parser (for example, the IBM Dharma parser). This corresponds to Step 0 of FIG. 4. This provides a valid and standard HTML base to start from. The invalid formatting, as far as XML is concerned, of some HTML tags in a normal Web page would otherwise cause problems for the XSLT processor used later.

Now consider an example presentation skeleton for the login page of FIG. 5a, as shown in Sample Code 3:

<?xml version=“1.0” encoding-′ iso -8859-1”?>

| | |
|---|---|
| <widget:HTML | id=“login” |

xmlns:widget=°http://www.hursley.ibm.com/hsandt/et/widget”>

<HEAD>

<TITLE!User Logon</TITLE!

</FIEAD>
<widget:BODY id= “component. body.itv.login”>

<TABLE height=“447” cellpadding=“0” cell spacing-
0” border=“0”

width=“591”!

<TgODY>
<TR>

<TD colspan=“5” height=“317”!

<widget:IMAGE id=“IMAGES.trans”/>

</TD> </TR> <TR>

<widget:TABLE id=“component.table. row. but
tonrow”/> </TR> <TR
align=“center” valign=“middle”>

<widget:TABLE id=“ component. table. row. linkrow”/> </TR> <TR>

<widget:TABLE id=“ component. table. row.
bottombar”/> </TR> </TBODY>
</TABLE!

</widget:BODY>

</widget:HTML>

### Sample Code 3

This login page contains a table with four rows. The first row is a spacer row specifically for this page. The next three rows include the content of the page, including the buttons and the links. Three components are referenced which represent these three rows. Components are also referenced which define the overall body style and assign a page id to the top most HTML tag.

As described above, components are pre-built blocks of markup, initially represented in a skeleton file as XSL component tags which are then processed to insert the components themselves. These blocks of mark up can either be static mark up or may include XSL statements to introduce dynamic data into the page from the input XML.

The identification and creation of components can be exercises to be performed by a developer, depending on which components are already defined within a repository of the XSLT style sheet generator tool. It will be appreciated by persons skilled in the art that many different criteria may be applied to determine which items to handle as XSL components, but in a first implementation the following criteria are applied:

A component reference should replace any item or items in the page mark up where the item or items:

1. Constitute dynamic data that will be extracted from the input XML at run time; or

2. Appear on more than one page in the site; or

3. Introduce device specific mark up to the page.

The first and third of these three types of item can be identified within an original HTML document, at least in part, by searching for members of a specific set of XSL statements and HTML items (for example work on the assumption that all scripts are device-specific and handle all scripts as components). The second type can be identified using autocorrelation string matching techniques. It will be appreciated by persons skilled in the art that once such criteria have been defined, they can be implemented in program code and then applied automatically within a computer program tool. For an optimal abstraction of components, there may remain items that should be mapped to components whose mapping cannot be automated by such a tool. For instance, HTML provided by a graphic designer will typically all be static and it may be necessary to refer to collateral information to determine which data displayed on the page will be static or dynamic in the target application.

The vocabulary of the component (‘widget’) namespace is designed to cover many of the default GUI concepts a user will be likely to require. The tags take the form:

<widget:TAGNAME id=“tagid”/>

Where the TAGNAME is the type of the tag and the id identifies the particular tag in question. The following tag names are defined:

| Tagname | Description |
|---|---|
| widget:INPUT | Input elements that you would find in |
| | forms. These may include check boxes, radio |
| | buttons, text, text areas, passwords and |
| | selections. It is important to repeat |
| | however that there is little pointing |
| | creating and referencing static markup |
| | components that will appear on one page |
| | only. This is frequently the case with form |
| | components. A notable exception is the |
| | selection box. |
| widget:TABLE | Table or table parts |
| widget:IMAGE | Image references. It is useful to reference |
| | images rather that code them directly in |
| | each page as it supports consistency |
| | checking and image file management. |
| widget:SCRIPT | Any script that is included in the page. |
| | One of the biggest differences between |
| | devices that support HTML is in the |
| | specification of the scripting that they |
| | support. Including a reference to a script, |
| | as opposed to the script itself, allows the |
| | device-specific script to be inserted as |
| | required. |
| widget:LINK | Link reference. It is useful to reference |
| | links rather than code them directly in |
| | each page as it allows an external link map |
| | (a database of information about the page |
| | links in the web application) to be |
| | generated. Such a link map dictates the |
| | navigation of the site and presents the |
| | possibility of being able to visualize and |
| | manage navigation without reference to each |
| | of the individual pages. |
| widget:BODY | General layout tags. The BODY tag defines |
| | some of the aspects of the look and feel of |
| | the page. As such, body components can be |
| | referenced to produce a common look and |
| | feel across many pages. This is |
| | conceptually similar to the HTML tag |
| widget:STYLE | Style elements used across the site, such |
| | as fonts. |
| widget:TEXT | Generic text to be included in a page. It |
| | is useful to reference rather than included |
| | text that appears on more than one page. |
| widget:PART | Arbitrary blocks of markup that don't fit |
| | into the categories above |

Additional tag names can be specified as required. The replacement of an XSL component tag for the component mark up is an XSLT process in itself. For example, consider the replacement of the tag:

<widget:TABLE id=“component.table.row.buttonrow”/>

with its related component. The following XSLT template performs this replacement:

<xsl:template match=“widget:TABLE
[@id=‘component.table.row.buttonrow’]”>

<TD colspan=“5” height=“37”>

<widget:IMAGE id=“IMAGES.MasterLpanel2”/>
<widget:IMAGE id=“IMAGES.Redbut”/>
<widget:IMAGE id=“IMAGES.Greenbut”/>
<widget:IMAGE id=“IMAGES.Bluebut”/>
<widget:IMAGE id=“IMAGES.Yellowbut”/>
<widget:IMAGE id=“IMAGES.MasterLpanel1a”/>

</TD>

</xsl:template>

It can be seen here that the template matches the specifics of the ‘widget’ tag and then replaces the tag with the real mark up.

Pre-Processing Presentation Skeletons

The pre-processing stage then is a matter of replacing all of the ‘widget’ tags with the appropriate markup for the device in questions. This process is itself performed using a set of style sheets.

It should be noted that in the example in the previous section the component itself includes IMAGE tags which themselves must be expanded into the real image references. This hierarchy of tags is perfectly valid. The implication is that the process is re-run until all tags have been replaced.

The result of pre-processing the login page in this particular example is a static HTML page which can be retrieved from a web server like any normally generated HTML page. The processing associated with the login page is thus confined to design time.

The ‘recipes’ Web page shown in FIG. 5b, however, has dynamic content. The result of pre-processing this page will be an XSLT style sheet. This style sheet will, at run time, take input in the form of XML from the application and produce an HTML page for display, which includes all the available recipes.

Building the Next Page

On the face of it, with the login page example, we have expended a lot of effort to simply get back to where we started. However the value of this will become clear as we now consider the presentation skeleton for the recipes page, as shown in Sample Code 4:

<?=1 version=“1.0” encoding=“iso-8859-1”?>

| | |
|---|---|
| <widget:HTML | id=“recipes” |

xmlns:widget“http://www.hursley.ibm.com/hsandt/et/widget“>

<HEAD>

<TITLE>Todays Recipes</TITLE>

</HEAD>
<widget:BODY id=“component.body.itv.recipes”>

<H2>Show time; 1400-1500

</H2>

<FORM method=“get”

action=“http://nthursleyl.hursley.ibm.com/webapp/commerce/servlet/
CookInToday/view
ing
redients.jsp”>

<TAgLE- height=“485” cellpadding=“0” cell spacing=“ 0”
border=“0”

width=“605”>

<TBODY>
<TR valign=“top”>

<TD valign=“top’ colspan=“4” height=“49”>

<widget:IMAGE id=“IMAGES.”/>

</TD>

</TR> <TR>

<TD height=“≧1” colspan=“4”>
<widget:TABLE
id=“component.table.recipeheader”/>

<widget:IMAGE id=“IMAGES.trans”/>

</TD>

</TR> <TR valign=“top”>

<TD valign=“top” colspan=“4” height=“471”>

<TABLE cellpadding=“0” cellspacing=“0”
border=“0”

width=“100%”>

<TBODY>
<TR>
<TD rowspan=“2” colspan=“2”>

<widget:IMAGE
id=“IMAGES.WhitlelineTL”/>

</TD>

<TD bgcolor=“#FFFFFF” width=“562”>

<widget:IMAGE id=“IMAGES trans”/>

</TD>

<TD rowspan=“2” colspan=“2”>

<widget:IMAGE
id=“IMAGES.WhitlelineTR”/>

</TD>

<TD width=“10” rowspan=“3”>

<widget:IMAGE id=“IMAGES.trans”/>

</TD>

</TR>
<TR>

<TD width=“562”>

<widget:IMAGE id=“IMAGES.trans”/>

</TD>

</TR>
<TR>

<TD bgcolor=“#FFFFFF” height=“307” width=“3”>

<widget:IMAGE id=“IMAGES.trans”/>

</TD>

<TD height=“307” width=“31”>

<widget:IMAGE id=“IMAGES.trans”/>

</TD>

<TD height=“307” width=“562”>

<widget:TABLE

id=“component.table.recipelist”/>

</TD>

<TD height=“307” width=“31”>

```
  <widget:IMAGE id=“ IMAGES. trans 11
  />
```

</TD>
<TD bgcolor=“#FFFFFF” height= “307”
width=“3”>

<Ii4G height=“1” width=“3”

src=“images/trans.gif”/>

</TD> . </TR> <TR>
<TD rowspan=“2” colspan=“2” height=′−4”>

<widget:IMAGE
id=“IMAGES.WhitlelineBL”/>
</TD>

| | |
|---|---|
| <TD height=“28” width=“562”> | - |

<widget:IMAGE id=“IMAGES.trans”/>
</TD>

<TD rowspan=“2” colspan=“2” height=“4”>

<widget:IMAGE
id=“IMAGES.WhitlelineBR”/>

</TD> </T,R> <TR>
<TD bgcolor=“#FFFFFF” height=“3”
width=“562”>

<widget:IMAGE id=“IMAGES.trans”/>

</TD> </TR> <TR>
<TD width=“3”>

<widget:IMAGE id=“IMAGES.trans”/>

</TD> </TR> <TR>
<widget:TABLE

id=“component.table.row.buttonrow”/> </TR> <TR>

<TD colspan=“5” height=“10”>

<widget:IMAGE id=“IMAGES.trans”/>
<TABLE cellpadding=“00” border=“0”

width=“100%”>

<TBODY>

<TR align=“center”

valign=“middle”>

<widget:TABLE

id=“component.table.row.linkrow“/>

/TR>
<TR>

<widget:TABLE

id=“component.table.row.bottombar”/>

/TR>

</TBODY>

</TAHLE>

</TD>

</TR>

</TBODY>

</TABLE>

</TD>

</TR>

</TBODY>

</TABLE>

</FORM>

</widget:BODY>

</widget:HTML>

### Sample Code 4

The static HTML page, which is typical of what may be delivered by a design agency, is a sizeable piece of HTML running to a number of pages. It is rationalized by using references to components. Although reducing the size of the HTML files is not the main objective of this process, it is clear that after we have abstracted out some complex components the majority of the HTML in this skeleton is now purely concerned with positioning components on the page. We concern ourselves next with the function that the components must perform. The first two widget:TABLE tags include the recipe header and the recipe list into the page. Both of these items contain dynamic data. The first contains the time for which the recipes are valid. The second contains the recipe list itself. The last three widget:TABLE tags are the same as for the first screen.

Introducing Dynamic Data

As an example, we will consider how the recipe list is included in the final HTML page. The recipe list takes each <category> element from the input XML and presents them in an HTML table. Radio buttons are included so that the user can indicate which one should be viewed. An input box allows the number of servings to be specified.

The tag <widget:TABLE id=“component.table.recipelist”/> references the recipe list component in the presentation skeleton for the recipe page. The block of HTML that replaces this tag is shown in Sample Code 5:

<xsl:template match= “widget:TABLE
[Oid=‘component. table. recipelist’]”>

| | |
|---|---|
| <TABLE height=“306” border=“0“ width=“100%”> | _ |
| <TBODY> | |

<ont:apply-templates select=“//category”/>

<TR>

<TD colspan=“3”>
<TABLE cellpadding=“0” cell spacing=“0”
height=“28” border-“0”

width=“100%”>

<TBODY>
<TR>

```
<TD width=“2%” rowspan=“3”>
  <IMG height=“34” width=“21”
src=“/images/MasterLpanel2.gif”/>
</TD>
<TD bgcolor=“#FFFFFF” colspan=“2” height=“2”>
  <IMG height=“2” width=“1” src=“images/trans.gif”/>
< /‘D>
```

<TD width=“5%” rowspan=“3”>

```
  <IMG height=“34” width=“21”
  src=“/images/MasterLpanella.gif”/>
</TD> </TR> <TR>
<TD bgcolor=“#5D3475” height=“30” width=1146%I->
  <FONT size=“4” face=“Arial, Helvetica, sans-serifl’>
```

<B>
<A onClick=“history.back();“>BACR</A>

>

```
  </FONT>
<TD bgcolor=“#5D3475” height=“30” width=1147%”>
  <FONT size=“4” face=“Arial, Helvetica, sans-serif”>
```

```
<A href=“ingredients.html” al-t=“View”>
  <IMG height=“25” width=“232”
  src=“/images/vrecipe.gif”
```

border- “0”/>

</A>

</FONT> </TI)> </TR> <TR> <TD bqcolor-“#FFFFFF”
colspan=“2”>

<IiXG height=“2” width=“1”
src=“/images/trans.gif”/> </TD> </TR>

</TBODY>
</TABLE>
</TD>
</TR>
</TBODY>
</TABLE>

</xsl:template>

### Sample Code 5

So effectively this recipe list component introduces a table into the HTML page. In this example the ‘Back’ button and the ‘View Ingredients’ button are included in the component as static HTML, so that everywhere the recipe list is produced these buttons are also present. How coarse or fine a granularity to apply to separation of the components (that is, which items, such as what size or level of complexity) should be referenced components) is very much a design decision. The line of interest is <out:apply-templates select=“//category”/>. This looks like an XSL statement but the namespace is wrong. This is because we have a style sheet that is effectively writing another style sheet. As it is not in the xsl namespace this line is included as is in the output HTML. If it were in the xsl namespace it would be processed as an xsl instruction. We don't want this to happen until run time.

When the resulting file is subsequently converted into an XSLT style sheet the namespace of this line will be changed to xsl. Then at run time this line will match all of the ‘category’ elements in the input XML. The following run time template has been constructed to produce the recipe table elements.

<xsl:template match=“categoryList/Category”>

<TR>
<TD align=“left”>
<INPUT checked=“0” value=“{catid/@code}” type=“radio”

name=“recipe”><xsl:value-of select=“name”/></INPUT>

```
</TD>
<TD width=“100” align=“right”>
  <B>Servings:</B>
</TD>
<TD width=“40”>
  <INPUT value=“{servings}“ maxlength=“2” size=“2”
name=“servings”
```

type=“text”/>

</TD>
</TR>

</xsl:template>

Pre-Processing to a Style Sheet

We have created a presentation skeleton file. This file indicates how all of the components should be organized on the screen. All of the components have been written. The next step is to pre-process the skeleton file to introduce the component markup. After this the resulting file is pre-processed to change the ‘out:’ name space into the ‘xsl:’ namespace. The result is the run time style sheet that will, given input XML, produce the required HTML page.

Run Time Templates

As is the case in the recipes pages there is often formatting of dynamic data that is required at run time. This is performed by a run time template. It is often the case that design time components that introduce dynamic data into the page will have matching run time templates to format that data.

On the face of it this appears to be a complex approach to introducing dynamic data to the page. However the power of this approach is apparent if the same data appears on more than one page. In this case the templates are only written once. It is not often, if ever, the case that a web site has two pages with exactly the same data on. What would be the point? However it is often the case that parts of individual pages are repeated across the site. This underlines the importance of selecting the right components. It must be those aspects of pages that can be reused where possible. Otherwise adding components simply adds more complication to the generation of the pages.

Device Dependency

Now we have presentation skeleton files and components for two pages, how do we modify the Web pages for viewing on a different device such as when moving from DTV to PC if that necessitates changes. Let us consider two scenarios.

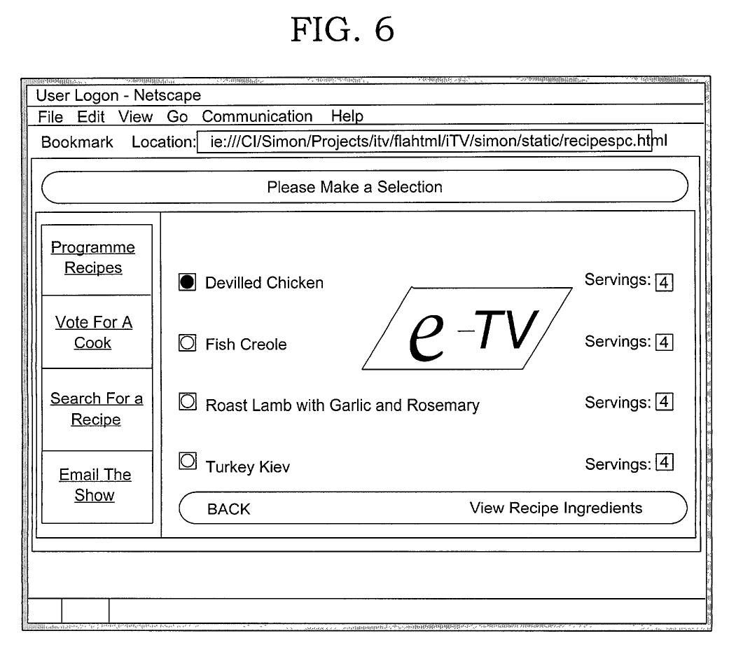

First, if the device requires different page design and layout, as is likely to be the case moving from DTV to PC, then new presentation skeletons are required but we may be able to use some of the same components. From the screen shot of FIG. 6, it is clear that the page design has changed. However, the component that produces the recipe list is the same as for DTV.

The (simplistic) presentation skeleton file which produced this layout is shown in Sample Code 6:

<?xml version=“1.0” encoding--“ iso-8859-1”?> <widget:HTML
id=“cookin.recipes“
xmlns:widget=“http://www.hursley.ibm.com/hsandt/et/widget”>
<HEAD>

<META name=“ GENERATOR” content=“IBM WebSphere
Page Designer V3.0.2 for

windows,,/>

<META http-equiv=“Content-Style-Type” content=“ text/css”/>
<TITLE/> </HEAD> <widget:BODY id=“cookin.main”>
<TABLE border-“1”> <TBODY> <TR>

<TD>

<widget:IMAGE id=“IMAGES.”/>

</TD>

</TR>
<TR>

<TD width=“610” height=11457”>

<TABLE border- “1”>
<TBODY>
<TR>
<TD height=“231” width=“101”>
<TABLE border=“1” height=“466” width=“94”>
<TBODY>
<T-R>

<TD height=“80”>

<B>

<widget:LINR id=”

Component. Link to. “>Programme Recipes</widget:LINK>

</B>

</TD>

</TR>
<TR>

<TD height=“721′>

<B>

<widget:LINR

| | |
|---|---|
| id=°Component.Linkto.”> | Vote For A Cook</widget:LINK> |

</B>

</TD>

</TR>
<TR>

<TD height=“92”>

<widget:LINR

| | |
|---|---|
| id=“Component.Linkto.”> | Search For a Recipe</widget:LINR> |

</B>

</TD>

</TR>
<TR>_{—}

<TD height=“102”>

<B>

<widget:LINR

| | |
|---|---|
| id=“Componen t.Linkto.”> | Email The Show</widget:LINK> |

</B>

</TD>

</TR>

</TBODY>

</TABLE>

</TD>
<TD>

<FORM

action=“http://nthursleyl.hursley.ibm_com/webapp/commerce/servlet/
CookInToday/View
Ingredients.jsp” method=“get”>

<widget:TABLE

id=“cookin.recipelist”/>

</FORM>

</TD>

</TR>

</TBODY>

</TABLE>

</TD>

</TR>

</TBODY>

</TABLE>

</widget:BODY>

</widget:HTML>

### Sample Code 6

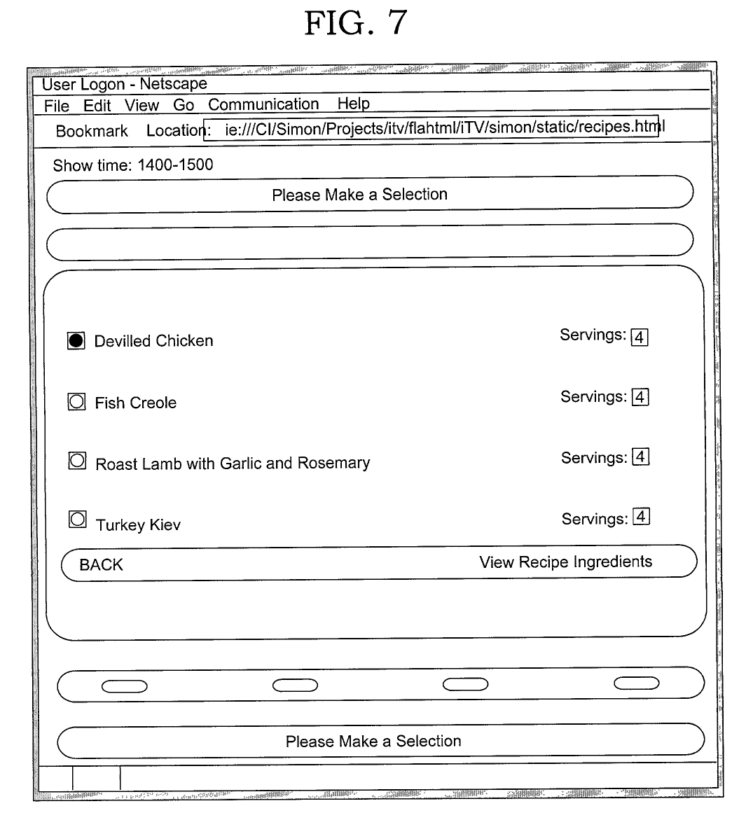

Secondly if we require a similar layout to the DTV device then we may choose to keep the same presentation skeleton files but modify the components. As a simple example, shown in the screen shot of FIG. 7, we can change the background image simply by changing the BODY component. With images, the advantages of being able to do this using the present invention are relatively small, as the contents of the image file that the pages reference could have been changed. However we can apply this technique to any aspect of the page by creating a component for it. For example, we could change fonts or other styles across the page simply by changing components. More importantly we can change the way that dynamic data is included simply by changing components.

CASE Tool Implementation Details

When operating a tool implementing the invention, there is a balance between the advantages described above and the possibility of introducing complexity without much benefit if there is no dynamic data and little reuse of items within the Web application. If the same screen looks completely different across devices and each screen has radically different style across the site then not much reuse is likely to be achieved. Using the present invention in such circumstances could involve more work than would be justified by the advantages it provides. In practice, however, it has been found that this problem does not usually arise and common components can be found. However the level of reuse achieved depends on the suitability of the rules applied to identify characteristics that should be referenced as XSL components or, in implementations which generate presentation skeletons more manually, depends on the skill of the designer in assessing the requirements of a site today and anticipating the changes that are likely to occur in the future.

The steps of the process described above can be executed one at a time, or in a batch, and applied to one page or a collection of pages selected by the user. The tool manages the input and output products of each stage of the process for each page. It allows pages to be reprocessed individually or collectively should requirements for a page change. Data from a website map (a database of information about the pages in the website) can be used in this context to indicate other pages in a site that may depend on the page being changed so that consistency is maintained. The tool manages a repository of XSLT components that can be extended by the user. It provides facilities for selecting and inserting components into a presentation skeleton. At least some of the operations of inserting components into page skeletons (such as abstraction of links to images) are amenable to automation and the tool provides these facilities. However, the tool also supports a number of operations being performed manually. A tree view of the presentation skeleton is presented to the user such that parts of the tree can be manually highlighted and replaced with a selected component tag. The tool includes a function to build and export the XSLT stylesheets that are the final output of the process described above.

In one embodiment of the invention, a Java servlet is provided which uses a site map data structure to model the web application such that it can accept HTTP requests for pages and use the model to determine an appropriate response. This response may be anything from some simple HTML documentation about the page (generated from the site map data structure) to the response that would be generated by the final application (that is, the application of a generated XSLT style sheet, which is a product of the process described above, to a sample of business XML).

A tool implementing the invention advantageously also includes a number of report generators that extract the information embodied in a site map data structure. In one embodiment, the reports include: maintenance documentation, code metrics, and project completion statistics, and additional reports may be added as desired. Information may be represented as a published report, or graphically as decoration on the graph view of the site.

As noted above, an XSLT style sheet generator tool implementing the invention includes a collection of XSLT style sheets and templates and functions for managing those style sheets and templates. These functions include:

Stylesheets that can mechanically replace presentation markup with pre-defined tags. An example would be a style sheet that processes HTML <IMG> elements to replace them with <widget:IMAGE> tags. The result from this style sheet must embody the information needed to properly restore the <IMG> tags later in the process. One way to do this is to make the result of the transformation itself an XSLT style sheet. This would consist of a collection of templates that matched each of the inserted <widget:IMAGE> tags. A function could be added in the GUI to present the information in this style sheet to a user in the form of a table that may be edited to change the mapping of images in the application. Changes thus made in the user interface can be reflected as changes made in the style sheet. Replacement of other presentation markup nodes with standard tags could proceed similarly. However, each function would be handled in a separate style sheet. In one embodiment, the GUI tool selects the elements to be replaced with tags, at any particular time, from a checklist. Each option checked on this list will equate to a style sheet. All stylesheets selected are composed (using the XSLT import mechanism) on the fly into one style sheet that can apply all the selected operations in one pass. A user can therefore apply any combination of the functions defined by these stylesheets.

A user of the tool will be able to manually select an abitrary portion of the presentation markup and replace it with a <widget:PART> tag. The strategy here is the same as above, with the information needed to later expand the tag being stored as an XSLT templates, except that this time the generation of the XSLT template and its association with the tag are driven by the user's interaction with the user interface.

Stylesheets that can mechanically replace pre-defined tags with presentation markup. There will be a one to one mapping between these and the tag insertion stylesheets outlined above. However, since piecemeal application of these stylesheets is not efficient, they are composed by the tool into a single large style sheet that implements the page layout expansion function (though they will be stored and managed as a number of discrete stylesheets). Application of this style sheet will set a flag in the tool that indicates whether the output includes any component tags or not (since a component may comprise sub-components). This transformation is applied repeatedly until no more tags remain to be expanded.

The result of the page layout expansion is presentation markup that includes XSLT statements. These XSLT statements have been protected from the XSLT processor up to this point by using a namespace prefix that refers to a namespace other than the defined XSLT namespace—so they get treated as data instead of instructions. The final step of the process is to convert the expanded page layout into an XSLT style sheet that can be executed at run-time. As part of this step the contained XSLT instructions must be rendered executable. This is done by mapping the namespace prefix used for these statements back to the standard XSLT namespace.

A new “widget” will be defined by supplying an XSLT style sheet that transforms some presentation language to include the newly defined tag and an XSLT stylsheet that replaces that tag with presentation markup and/or XSLT statements. The tool will include function that allows the operation of these stylesheets to be developed and tested in the context of the tool.

The process outlined utilizes many XSLT templates composed into style sheets in various ways. The significant problem of managing and organizing this XSLT code is the main driver behind defining a tool to control the process. Exactly how the XSLT code will be managed within the tool is an implementation detail, but it is noteworthy that the XSLT import and include mechanism access child stylesheets via URIs. This gives enormous flexibility in how XSLT stylesheets and templates are organized and stored. A relational or object database with support for XML is a realistic option.

The above description relates to example embodiments, but alternative implementations are equally possible. For example, instead of a single Web page design tool that incorporates the XSLT generation functions of the present invention, the XSLT generator could be implemented as an independent computer program which interfaces to Web site design tools from a number of different vendors, and this is especially true if the site map data structure is defined in open XML.

What is claimed is:

1. A method of generating a style sheet for applying presentation characteristics to Web page content for presentation by a presentation device, the method of generation including the steps of:
responsive to specified Web page presentation characteristics, generating a Web page presentation skeleton comprising a page layout definition which includes a representation of a subset of the specified presentation characteristics and includes references to one or more style sheet components corresponding to a second subset of said presentation characteristics, said style sheet components being held in a style sheet component repository; and
performing one or more style sheet transformations on the Web page presentation skeleton to replace said references with the corresponding style sheet components.

2. A method according to claim 1, wherein the replaced corresponding style sheet components include commands represented using a non-executable name format and wherein the method includes the subsequent step of converting the non-executable names to an executable command name format.

3. A method according to claim 1, wherein the referenced style sheet components include style sheet commands for applying presentation characteristics to dynamic data retrieved from a Web server.

4. A method according to claim 1, wherein the referenced style sheet components include presentation-device-specific blocks of markup language.

5. A method according to claim 1, wherein the referenced style sheet components include blocks of presentation markup language which are repeated within the Web page.

6. A method according to claim 1, wherein the generated style sheet is an XSLT style sheet for applying presentation characteristics to XML data.

7. A method according to claim 1, wherein the specified Web page presentation characteristics are input as blocks of markup and wherein the step of generating a Web page presentation skeleton comprises analyzing the input markup to determine a page layout definition and applying rules to identify the second subset of presentation characteristics to be handled as referenced style sheet components.

8. A method according to claim 7, wherein the step of applying rules comprises applying one or more style sheets which implement a predefined set of rules.

9. A method according to claim 7, including the step of adding a style sheet component to the style sheet repository when the identified second subset of presentation characteristics includes presentation characteristics for which no style sheet component exists in the repository.

10. A method according to claim 7, wherein the step of applying rules includes identifying elements within the input markup which require retrieval of dynamic data from a Web server, and providing within said presentation skeleton references to style sheet commands for applying presentation characteristics to dynamic data from a Web server.

11. A method according to claim 7, wherein the step of applying rules includes identifying presentation-device-specific elements within the input markup, and providing within said presentation skeleton references to presentation-device-specific style sheet components.

12. A method according to claim 7, wherein the step of applying rules includes identifying blocks of presentation markup which are repeated within the Web page, and providing within said presentation skeleton a plurality of references to each of said identified repeated blocks of presentation markup.

13. A method according to claim 1, wherein the step of performing one or more style sheet transformations comprises applying a set of XSLT style sheet templates.

14. A method according to claim 1, wherein the presentation skeleton is a markup language file and the references are markup tags within this file.

15. A method according to claim 1, including processing input data together with the generated style sheet to generate a Web page presentation for presentation by a presentation device.

16. A method according to claim 15, wherein said processing is performed by an XSLT processor processing input XML data together with one or more XSLT style sheets.

17. A method of generating a plurality of style sheets, each for applying presentation characteristics to Web page content for presentation by a different type of presentation device, the method comprising the steps of:
responsive to specified Web page presentation characteristics, generating a Web page presentation skeleton comprising a page layout definition which includes a representation of a subset of the specified presentation characteristics and includes references to one or more style sheet components corresponding to a second subset of said presentation characteristics, said style sheet components being held in a style sheet component repository;
performing a first set of style sheet transformations on the Web page presentation skeleton to replace said references with corresponding style sheet components to generate a style sheet for a first type of presentation device; and
performing a second set of style sheet transformations on the Web page presentation skeleton to replace said references with corresponding style sheet components to generate a style sheet for a second type of presentation device.

18. A method according to claim 17, including processing input data together with the style sheet for the first type of presentation device and separately processing the input data together with the style sheet for the second type of presentation device, thereby to generate Web page presentations for multiple device types.

19. A data processing apparatus comprising:
a processor;
a storage repository for storing a set of style sheet components; and
a set of controller components for accessing the storage repository and for controlling the operation of the data processing apparatus to perform a method of style sheet generation, the set of controller components including components for:
responsive to specified Web page presentation characteristics, generating a Web page presentation skeleton comprising a page layout definition which includes a representation of a subset of the specified presentation characteristics and references to one or more style sheet components corresponding to a second subset of said presentation characteristics, the referenced style sheet components being held in the storage repository; and
performing one or more style sheet transformations on the Web page presentation skeleton to replace said references with the corresponding style sheet components.

20. A computer program product comprising program code recorded on a machine readable recording medium for controlling the operation of a data processing apparatus on which it runs to perform a method of generating a style sheet, for applying presentation characteristics to Web page content for presentation by a presentation device, the program code comprising:
means, responsive to specified Web page presentation characteristics, for generating a Web page presentation skeleton comprising a page layout definition which includes a representation of a subset of the specified presentation characteristics and references to one or more style sheet components corresponding to a second subset of said presentation characteristics, the referenced style sheet components being held in the storage repository; and
means for performing one or more style sheet transformations on the Web page presentation skeleton to replace said references with the corresponding style sheet components.

21. A computer aided software engineering tool comprising:
a repository containing a set of predefined style sheet components;
a computer program for generating style sheets, for applying presentation characteristics to Web page content, the computer program comprising:
means, responsive to specified Web page presentation characteristics, for generating a Web page presentation skeleton comprising a page layout definition which includes a representation of a subset of the specified presentation characteristics and references to one or more style sheet components corresponding to a second subset of said presentation characteristics, the referenced style sheet components being held in the storage repository; and
means for performing one or more style sheet transformations on the Web page presentation skeleton to replace said references with the corresponding style sheet components;
a user interface for user control of the operation of said computer program;
wherein the computer program includes a component for creating additional style sheet components and adding the additional style sheet components to the repository, in response to user interactions via said user interface.
